(19) United States
(12) Patent Application Publication
(10) Pub. No.: US 2011/0266973 A1
(43) Pub. Date: Nov. 3, 2011

(54) SPIDER

(76) Inventor: Lothaire Alfred, Miami, FL (US)

(21) Appl. No.: 12/916,722

(22) Filed: Nov. 1, 2010

Related U.S. Application Data
(60) Provisional application No. 61/257,076, filed on Nov. 2, 2009.

(51) Int. Cl. H05B 37/02

(52) U.S. Cl. 315/297; 315/320

(57) ABSTRACT

The Spider is a lighting control device that has the capability of controlling a light source from multiple switches if pressed randomly, making it possible for a user to turn lights on and off using multiple switches. This device may be placed virtually anywhere within a room to allow the user to conveniently and safely turn their lights on and off with ease, from the user-preferred location(s). The device also features a time delay, which enables the user to turn on a light and then preset the amount of time before it automatically turns off. The invention consists of an enclosure with touch-pad capability and may include numerous ICs, capacitors, IC regulators, resistors, regular electrical switches, AC outlets, push-button switches, and a transformer for the power supply. The device may manipulate up to 12 push-button switches or more in certain embodiments.

### CROSS-REFERENCE TO RELATED APPLICATION

The present application is related to and claims priority from prior provisional application Ser. No. 61/257,076, filed Nov. 2, 2009, which application is incorporated herein by reference.

### COPYRIGHT NOTICE

A portion of the disclosure of this patent document contains material which is subject to copyright protection. The copyright owner has no objection to the facsimile reproduction by anyone of the patent document or the patent disclosure, as it appears in the Patent and Trademark Office patent file or records, but otherwise reserves all copyright rights whatsoever. 37 CFR 1.71(d).

### BACKGROUND OF THE INVENTION

1. Field of the Invention

The following includes information that may be useful in understanding the present invention(s). It is not an admission that any of the information provided herein is prior art, or material, to the presently described or claimed inventions, or that any publication or document that is specifically or implicitly referenced is prior art.

The present invention relates generally to the field of lighting and more specifically relates to a lighting control device that has the capability of controlling a light source from multiple switches if pressed randomly.

2. Description of the Related Art

Modernly, lights may be used to illuminate areas to provide increased visibility for individuals. Lights are often powered via electricity and may be operated by switches between on and off positions. Switches are often traditionally recessed within a finished wall. Surface mounting is also fairly common though is seen more in commercial industrial and outbuilding settings than in houses. These switches are typically located on vertical walls, often near entrances and exits of rooms, hallways, stairways and other positions. Although electricians and builders attempt to put these switches in convenient locations, inevitably an individual must either walk through the dark before or after activating the switch to avoid retracing steps which may prove to be dangerous.

A convenient solution is to install a two-way light switch in strategic locations in the home to save individual's time and effort for example near a staircase so that they can turn the light on at the bottom of the steps, and turn it off when they reach the top. However, multiple light switches may be rare in a home due to their per/unit cost combined with the fees incurred from a complex installation. Individuals as a result may be left with the option to either leave the light on, which can consume expensive energy, or retrace their steps to turn the light off. Thus, a need exists for controlling a light source from multiple switches.

Various attempts have been made to solve the above-mentioned problems such as those found in U.S. Pat. Nos. 5,066,898 and 4,204,204. This prior art is representative of lighting control devices. None of the above inventions and patents, taken either singly or in combination, is seen to describe the invention as claimed.

Ideally, a lighting control device should be reasonably and readily installable and, yet, would operate reliably and be manufactured at a modest expense. Thus, a need exists for a reliable lighting control device system, “The Spider” that has the capability of controlling a light source from multiple switches if pressed randomly and to avoid the above-mentioned problems.

### BRIEF SUMMARY OF THE INVENTION

In view of the foregoing disadvantages inherent in the known lighting art, the present invention provides a novel lighting control device and system. The general purpose of the present invention, which will be described subsequently in greater detail is to provide a lighting control device that has the capability of controlling a light source from multiple switches if pressed randomly.

A lighting control device and system is disclosed herein comprising: a plastic enclosure with an inner-volume providing a protective housing and providing at least one mounting surface; at least one (mounted) touch-pad with at least one push-button (input) switch (preferably a multitude of switches); a transformer for transferring electrical energy from one first circuit to at least one second circuit; at least one timer; at least one logic switcher; at least one buffer for buffering; and at least one capacitor. The system further preferably comprises at least one inverter for converting direct current to alternating current; at least one logic controller and a user-activatable pre-settable time delay usable to automatically turn off light(s) at a specified user-defined interval; at least one analog and/or digital switch; at least one resistor; at least one potentiometer. The lighting control device may also comprise tri-state circuitry and digital gates for feeding the communications therethrough.

The lighting control device is preferably portable such that the device is removably installable at different locations within an interior room (preferably interior, but in other embodiments may be exteriorly located). The lighting control device is connectable and operable through telephone wires (or other such communicating medium). The power supply is connected to the timer, the logic switcher, the logic controller, and the switch(es). The lighting control device is housed by a plastic (or other such suitable material) enclosure and is manipulatable via the touch-pad thereby enabling the user to have the capacity to turn a plurality of lights on and off using multiple switches when the switches are activated by the user. The push-button switches are able to be pressed randomly; and will turn a light on, while any other of the push-button switches or the same push-button switches can turn the light(s) (or other powered device) off.

A method of using a lighting control device is also disclosed herein and may comprise the steps of: pushing at least one push-button switch on a touch-pad (conveniently located) thereby activating at least one light at a remote location; wherein one of the push-button switch(es) will turn at least one light on, while any other of the push-button switches or the same push-button switch(es) can turn the light off; wherein the push-button switch(es) are randomly pressable; and activating a pre-settable time delay usable to automatically turn off the light(s).

The present invention holds significant improvements and serves as a lighting control device and system. For purposes of summarizing the invention, certain aspects, advantages, and novel features of the invention have been described herein. It is to be understood that not necessarily all such advantages may be achieved in accordance with any one particular embodiment of the invention. Thus, the invention may be embodied or carried out in a manner that achieves or optimizes one advantage or group of advantages as taught herein without necessarily achieving other advantages as may be taught or suggested herein. The features of the invention which are believed to be novel are particularly pointed out and distinctly claimed in the concluding portion of the specification. These and other features, aspects, and advantages of the present invention will become better understood with reference to the following drawings and detailed description.

### BRIEF DESCRIPTION OF THE DRAWINGS

The figures which accompany the written portion of this specification illustrate embodiments and method(s) of use for the present invention, “The Spider”, constructed and operative according to the teachings of the present invention.

FIG. 1 shows a perspective view illustrating a lighting control device, entitled “The Spider”, according to an embodiment of the present invention.

FIG. 2 is another perspective view illustrating the lighting control device, according to an embodiment of the present invention of FIG. 1.

FIG. 3 is a flowchart illustrating a block diagram of components of the lighting control device according to an embodiment of the present invention of FIG. 1-2.

FIG. 4 is a flowchart illustrating an electric schematic for the lighting control device according to an embodiment of the present invention of FIG. 1-3.

FIG. 5 is a flowchart illustrating another electric schematic for the lighting control device according to an embodiment of the present invention of FIG. 1-4.

The various embodiments of the present invention will hereinafter be described in conjunction with the appended drawings, wherein like designations denote like elements.

### DETAILED DESCRIPTION

As discussed above, embodiments of the present invention relate to a lighting control device and more particularly to “The Spider” as used to provide the capability and means for users to control a light source from multiple switches when pressed randomly. Multiple light switches as aforementioned are rare in home constructions due to their costs and complex installation. Individuals are forced to either leave the light on, which can consume energy, or retrace their steps to turn the light off, possibly forcing him/her to walk in an unlit area, thus creating potential dangers. Therefore a need exists for controlling a light source from multiple switches which the present invention serves to solve.

Generally, the Spider is a lighting control device that has the capability of controlling a light source from multiple switches if pressed randomly. This device may be placed virtually anywhere within a room to allow the user to turn their lights on and off with ease, from virtually any convenient location. The device also features a time delay in one of the embodiments shown, which will enable the user to turn on a light and then preset the amount of time before it automatically turns off. This product may be easily installed in a home or business. It should be appreciated that the present invention may be useful for hallway entrances and exits, large rooms with multiple lighting system(s).

The Spider makes it possible to turn lights on and off using multiple switches. The invention comprises a small plastic box (or larger with big installations) with touch-pad capability. The materials used are the same as in the construction of two-way, three-way, and other multiple light switches. These materials may include numerous ICs, capacitors, IC regulators, resistors, regular electrical switches, AC outlets, push-button switches, and a transformer for the power supply. Upon placement of this device, the possibility of turning on and off the existing light may be accomplished with different push-button switches pressed randomly. (The push-button switches pressed “randomly” within this disclosure means one switch will turn the light on, while any other or the same switch, can turn it off). The device may be able to manipulate up to 12 push-button switches or more within other embodiments. The device may also include a time delay, which allows the light to stay on for a pre-determined amount of time before it automatically turns off. This option may be activated by the user.

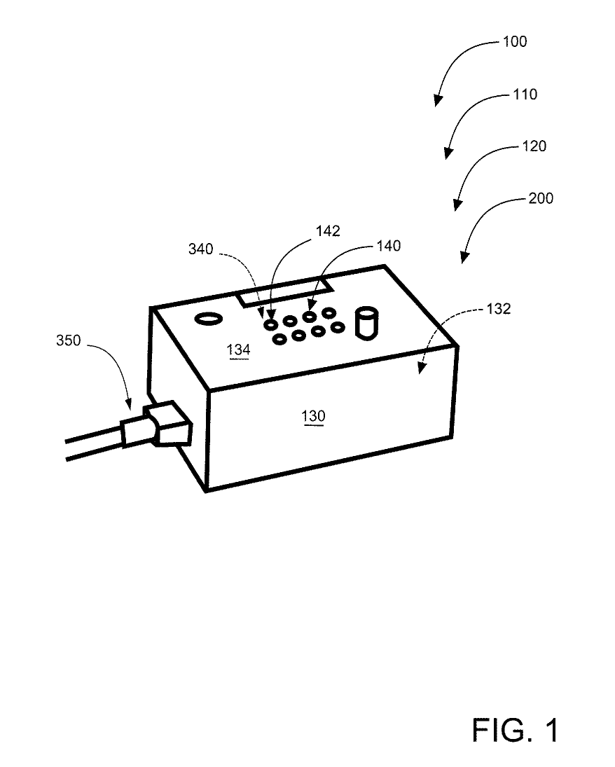

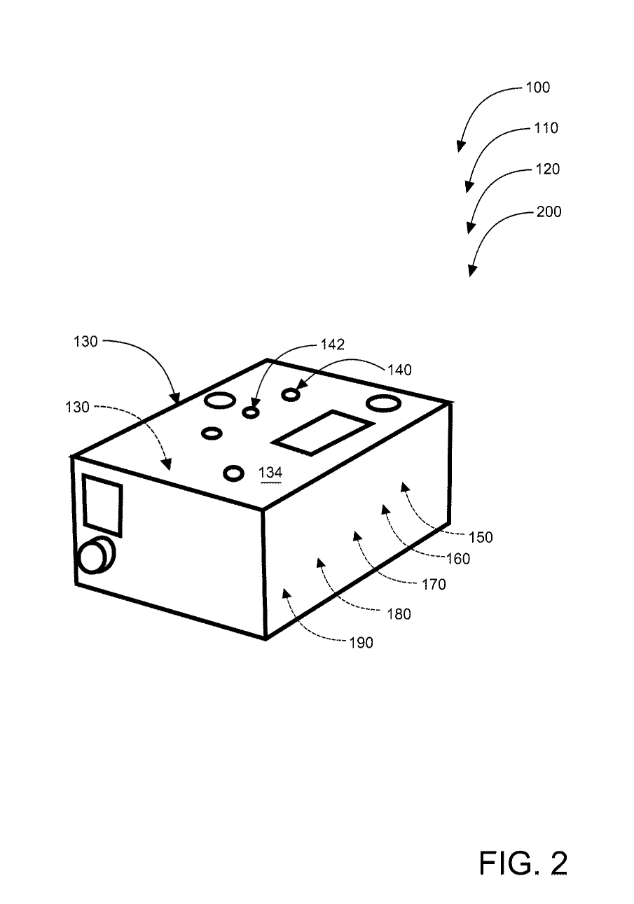

Referring now to the drawings by numerals of reference there is shown in FIGS. 1-2, perspective views illustrating lighting control device 120, entitled “The Spider” 110, according to an embodiment of the present invention.

Lighting control device 120 preferably comprises: a plastic enclosure 130 (or other such suitable material—plastic being preferred because of its lightweight and non-corrosive properties), enclosure 130 having at least one inner-volume 132 thereby providing a protective housing and at least one mounting surface 134. Lighting control device 120 preferably further comprises at least one touch-pad 140 with at least one (preferably a plurality of) push-button switch(es) 142. Push-button switch(es) 142 of touch-pad 140 may comprise input buttons. In certain embodiments the present invention may comprise a transformer 150 for transferring electrical energy from one first circuit to at least one second circuit.

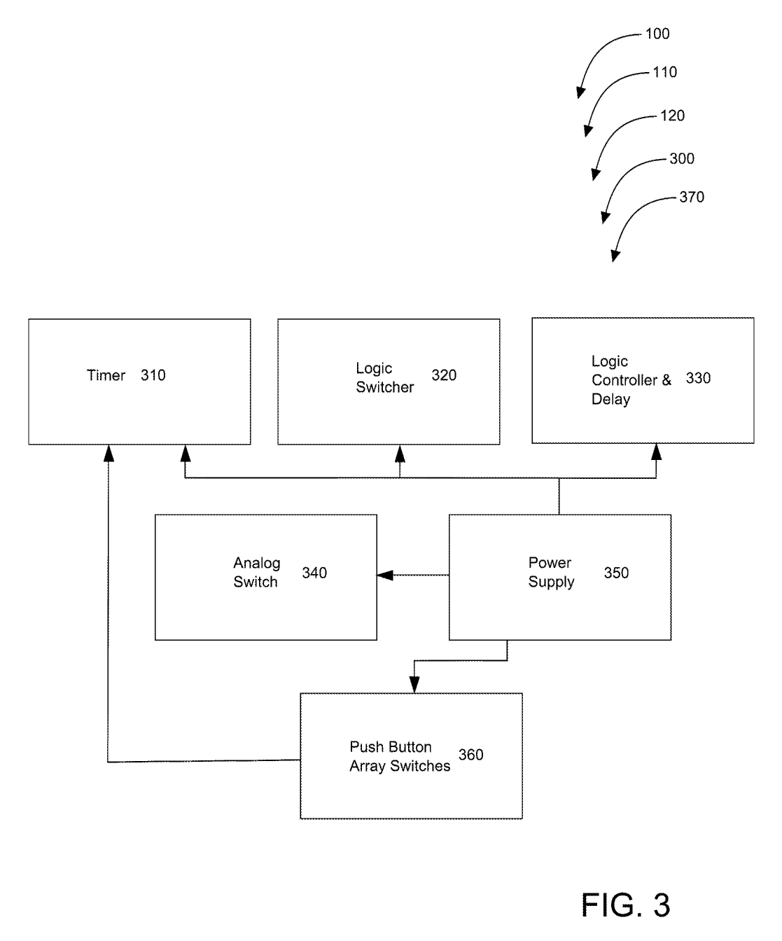

In the preferred embodiment lighting control device 120 preferably comprises at least one timer 310 (or other sufficient timing means); at least one logic switcher 320 (both of which alluded to in FIG. 3); at least one buffer 160 for buffering; at least one capacitor 170 acting electronically passively including a pair of conductors separated by a dielectric insulator; at least one inverter 180 for converting direct current (DC) to alternating current (AC); at least one logic controller and delay 330, the user-activatable pre-settable time delay usable to automatically turn off at least one light at a desired time interval. The present invention will find use in many applications such as in senior citizens homes where for example two or more individuals are in a common room for sleeping—this way the individuals all have convenient access to lighting controls without requiring them to leave their bed(s). As can be appreciated the instant invention may be used for a multitude of applications and increase the convenience and safety for the user(s).

Additionally, lighting control device 120 preferably comprises at least one analog switch 340 and/or digital switch; at least one resistor 190 that produces a voltage across its terminals that is proportional to the electric current through it; at least one potentiometer 210 providing an adjustable voltage divider. Lighting control device 120 preferably comprises tri-state circuitry and digital gates (and's, nann's and or's) for feeding/communicating therethrough; wherein lighting control device 120 is portable such that lighting control device 120 is removably installable at different locations within an interior room. Lighting control device 120 is connectable and operable through telephone wires; wherein power supply 350 is connected to timer 310, at least one logic switcher 320, at least one logic controller and delay 330, and at least one analog switch 340.

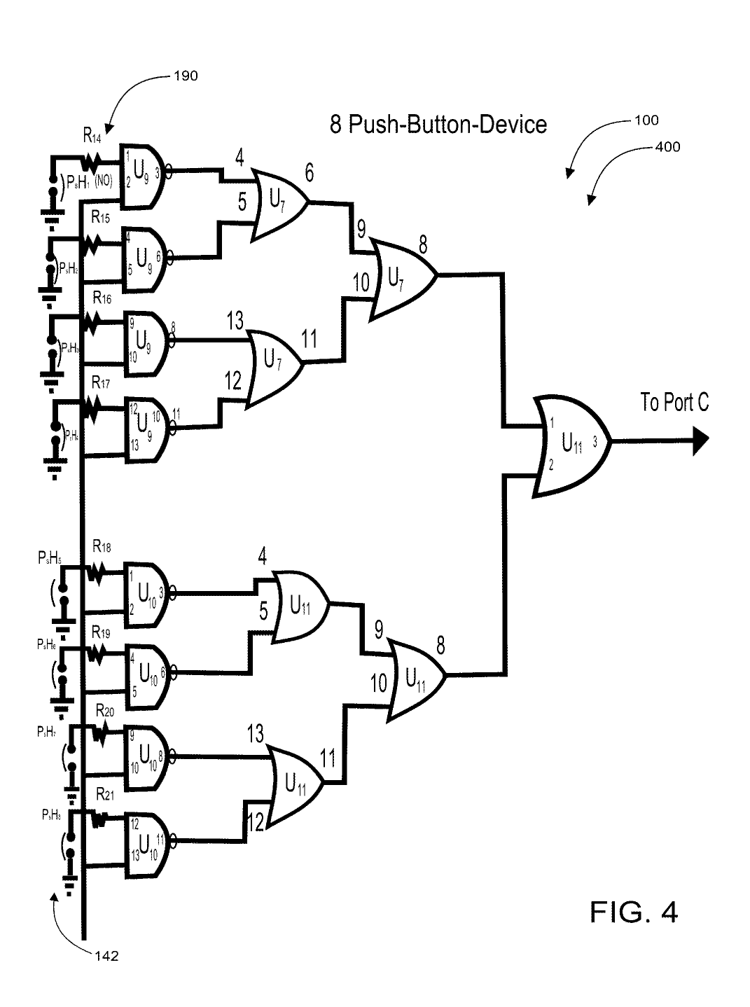

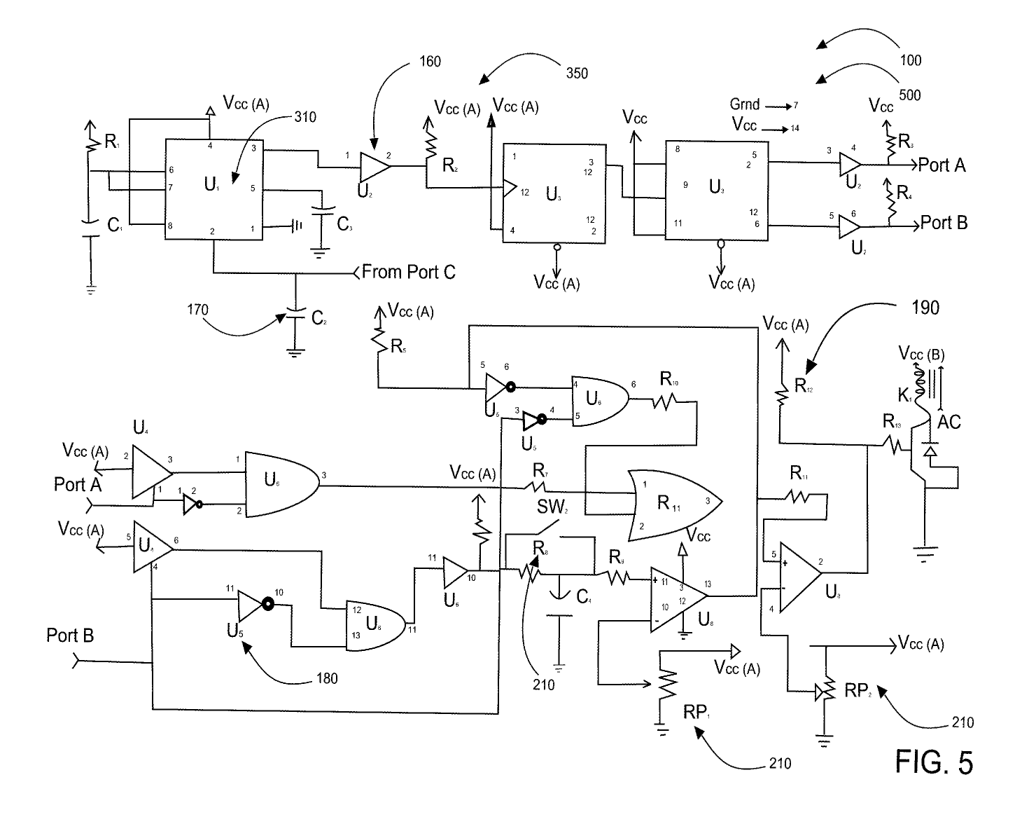

Lighting control device 120 is suitably and protectively housed by enclosure 130 and is preferably manipulatable via touch-pad 140 by at least one user thereby providing the capacity to turn a plurality of lights on and off using multiple switches 142 when switches 142 are activated by the user; wherein push-button switches 142 are able to be pressed randomly; such that one of push-button switches 142 will turn a light on, while any other of push-button switches 142 or the same push-button switch(es) 142 can turn the light(s) off. In this way lighting control device 120 can be used by manipulating/activating upon pushing at least one push-button switch 142, in other embodiments up to eight, as shown in the following FIGS. 4 and 5, and in other embodiments, more than twelve push-button switches 142. FIGS. 4 and 5 enable an embodiment having eight push-button switches 142.

Referring now to FIG. 3, showing flowchart 300 illustrating block diagram 370 of the various components of lighting control device 120 and their relative relationship to one another according to an embodiment of the present invention of FIG. 1-2.

Lighting control system 100 as shown in block diagram 370 comprises the following components: timer 310; logic switcher 320; logic controller and delay 330; analog switch 340 (analog version shown here, however may be digital in certain embodiments); power supply 350; and push-button array switches 360. As shown power supply 350 is in communication with timer 310; logic switcher 320; logic controller and delay 330; and analog switch 340. Further, push-button array switches 360 are in communication with timer 310, as shown in flowchart 300.

The following is a materials list that may be used in conjunction with the following FIGS. 4 and 5 to reproduce one of the disclosed preferred embodiments.

Materials List:

| Materials | Value or Type |
|---|---|
| R₁, R₈ | 4.7k |
| R₂, R₃, R₄ | 10k |
| R₅, R₆, R₇, R₉, R₁₀, R₁₁, | 1k |
| R₁₂, R₁₃, R₁₄, R₁₅, R₁₆, R₁₇, R₁₈, | |
| R₁₉, R₂₀, R₂₁ | |
| U₁ | TLC 555 (Timer) |
| U₂ | 7407 |
| U₃ | 74LS107 |
| U₄ | 74LS125 |
| U₅ | 7404 |
| U₆ | 74LS08 or other |
| U₇, U₁₁ | 74LS32 or other |
| U₈ | LM339 |
| U₉, U₁₀ | 7400 |
| C₁ | 1000 uF, 25 V |
| C₂ | .01 uF |
| C₃ | .1 uF |
| C₄ | 4(1000 uF) in parallel |
| RP₁, RP₂ | 50k Potentiometer |
| Psh₁, Psh₂, Psh₃, Psh₄, Psh₅, | Push-Button Switch |
| Psh₆, Psh₇, Psh₈ | Normally Open Type |
| K₁ | May be 12 Volt or 24 Volt relay. |
| | The AC rating can be 5 A or higher |
| Q₁ | 2N2222 |
| | (or one of higher rating may be used) |
| D₁ | IN4003 |
| Sw₁ | SPST |

*Note: Virtually any DC type power supply may be used as long as Vcc_{(A)} is 5 volts and rated at 1 A or higher. Vcc_{(B)} is a 12 volt source and its rating will depend on the relay type.

Referring now to FIGS. 4 and 5, showing electric schematics 400 and 500, respectively for lighting control device 120 according to an embodiment of the present invention of FIGS. 1-3. FIGS. 4 and 5, show electric schematic 400 and electric schematic 500 which can be followed while reading this portion of the specification (and using the above-provided materials list) to understand the ‘flow’ in order to sufficiently reproduce lighting control device 120. Flow will be described generally from left to right working generally downwardly from top to bottom on the page in the figures.

Beginning with FIG. 4 showing electric schematics 400 labeled 8 Push-Button-Device, it should be appreciated that the present invention may use from one push-button switch 142 to a large number of push-button switches 142 (expandable or shrinkable in number and size according to the desired application for use) and that the illustration is to provide exemplary means for reproducing the invention and is not to be construed as limiting in any way. Push-button switches 142 are shown on the left-hand side of the page. In the embodiment shown there are eight push-button switches 142 (labeled Psh₁-Psh₈). These are labeled as grounded, as indicated by the ground arrows. Additionally it should be noted that Psh₁-Psh₈ push-button switches 142 are connected to resistors 190 (labeled R₁₄-R₂₁) in communication with four of U₉ NAND gates and four of U₁₀ NAND gates (located underneath the U₉ NAND gates). U₉ NAND gates are connected to two of U₇ OR gates, then through another U₇ OR gate to the U₁₁ OR gate which goes to Port C on the following electric schematic 500. The four U₁₀ NAND gates are connected to two U₁₁ OR gates, then through another U₁₁ OR gate, then through the last U₁₁ OR gate shown leading to Port C. FIG. 4 represents two banks of four gates, each bank embedded on one chip for installation in enclosure 130 of The Spider 110. All pin numbers are designated and the flow is towards Port C which is explained and shown in greater detail in the following FIG. 5, showing electric schematic 500.

Referring now to FIG. 5, showing electric schematic 500 starting in at From Port C we find capacitor 170 C₂ which is grounded as indicated. Flow continues into U₁ clock (timer 310) and as indicated the present invention comprises only one timer 310 (other embodiments may comprise more timers 310). Pins 6 & 7 are in connection with R₁ (resistor 190) and C₂ (capacitor 170) and each are grounded. U₁ clock is also connected to C₃ (capacitor 170) via pin 5, pin 1 is to ground, and pin 4 to Vcc is to power supply 350 (all Vcc connect to power supply 350). Next, flow communicates through U₂ (buffer 160), it should be noted that there are six of U₂ (buffers 160) within the present embodiment, 8 Push-Button-Device version.

Flow next goes into U₃ (J Flip-Flop) and into another U₃ (J Flip-Flop) and through another U₂ (buffer 160) to Port A or to Port B via U₂ (buffer 160). Other Vcc connections to power supply 350, resistors 190 (such as R₃) and ground indicator arrows are shown. Ground is from pin 7 and Vcc is connected through pin 14 as shown. Thus the upper portion of FIG. 5 is suitably enabled from Port C to Port A and/or to Port B. It should also be appreciated that pins are suitably numbered.

Referring now to the lower portion on FIG. 5, showing entry into Ports A & B, into U₄, preferably a Tri-state chip (or other suitable equivalent) providing separate entrances into Ports A & B and hooked to Vcc (connected to power supply 350). It should be noted that there are two of U₄, (Tri-state chips), one shown above the other on the present figure. The flow along the upper portion (to Port A) next flows through to U₆ AND gate either through pin 3 to pin 1 or via U₅ (inverter 180) through pin 1 to pin 2. From Port B the route is traced from U₄, (Tri-state chip), to U₆, either directly or via U₅ (inverter 180). Next inline (after U6) is U₂ and resistor 190 (R₆) and Vcc (connected to power supply 350) before U₅ (inverter 180). As shown an optional route may be from U₄, Tri-state chip to U₅ (inverter 180). U₅ (inverter 180) is in connection to U₆ through pin 5. If leaving U₆ route may be through R₁₀ (resistor 190) to R₁₁ (resistor 190) to U₈ (a comparator gate) to R₁₃ (resistor 190) to Vcc_{(B)} connected to power supply 350 through R₁₃ (resistor 190) and K₁ (relay—the only component AC power goes into) or optionally when leaving R₁₃ (resistor 190) the path may proceed to ground via Q₁ (the controller of relay—controlled via U₈ comparator gate). As shown, Vcc_{(A)} is connected to power supply 350 through R₁₂ (resistor 190). D₁ comprises IN4003 within the present invention and S_{W1} comprises SPST, as indicated in the materials list. Sw₁ purposes to facilitate the full application of the delay feature wherein the timing can be manipulated by the user (or temporarily eliminated). Further, it should be appreciated that for manufacturing purposes the part of the circuit comprising C₄, R₈ and Sw₁ can be easily redesigned in order to enhance more user-consumer options.

Referring now back to U₂ (buffer 160), connection may be to SW₂ which may be open/closed or through R₁₂ (a regular version of resistor 190, as disclosed in materials sheet) inline with C₄ (capacitor 170), to ground or through R₉ (resistor 190) to lower illustrated U₈ (comparator gate) connected to R_{P1} (potentiometer 210 which is grounded and to power supply 350) via pin 10. Forwardly tracing flow through U₈ (comparator gate) may flow to U₅ (inverter 180) (hooked to R₅ (resistor 190) to Vcc) or through pin 6 to pin 4 into U₆ AND gate, then through R₁₀ (resistor 190) path as described above (into U₇ OR gate). As mentioned previously Pin 14 comprises power supply 350 and pin 7 comprises ground, as indicated via ground arrow designation. R₈ comprises a potentiometer 210 wherein its role is to vary the delay. Other details are indicated in the present FIGS. 4 and 5, showing electric schematics 400 and 500, and in combination with the provided materials list and FIG. 3 should provide one with common knowledge in the field to reproduce such lighting control system 100, as the one described herein. Further, using the exemplary 8 Push-Button-Device build instructions a user is able to fashion a much larger (or smaller) embodiment for use in controlling many or few lights or other such ‘powered’ devices in a similar fashion. Those with ordinary skill in the art will now appreciate that upon reading this specification and by their understanding the art of power and electronics as described herein, methods of powering electronic chips and configurations will be understood by those knowledgeable in such art.

Lighting control system 100, The Spider 110, may be sold as kit 200 comprising the following parts: at least one enclosure 130 at least one touch-pad 140; wherein touch-pad 140 may be removable; and at least one set of user instructions. Lighting control system 100 may be manufactured and provided for sale in a wide variety of sizes and shapes for a wide assortment of applications. Upon reading this specification, it should be appreciated that, under appropriate circumstances, considering such issues as design preference, user preferences, marketing preferences, cost, structural requirements, available materials, technological advances, etc., other kit contents or arrangements such as, for example, including more or less components, different sizes, different numbers and orientations of switches and push-buttons, customized parts, digital and/or analog, parts may be sold separately, etc., may be sufficient.

A method of using a lighting control device 120 of lighting control system 100 may comprise the steps of: pushing at least one push-button switch 142 on touch-pad 140 thereby activating at least one light at a remote location; wherein one of push-button switch(es) 142 will turn at least one light on, while any other of push-button switches 142 or the same push-button switch(es) 142 can turn the light off; wherein push-button switch(es) 142 are randomly (inputably) pressable; and activating a pre-settable time delay (logic controller and delay 330) usable to automatically turn off at least one light may occur. It should be noted that steps random pressing and use of the delay are optional steps and may not be implemented in all cases.

It should be noted that the steps described in the method of use can be carried out in many different orders according to user preference. Upon reading this specification, it should be appreciated that, under appropriate circumstances, considering such issues as design preference, user preferences, marketing preferences, cost, structural requirements, available materials, technological advances, etc., other methods of use arrangements such as, for example, different orders within above-mentioned list, elimination or addition of certain steps, including or excluding certain maintenance steps, etc., may be sufficient.

The embodiments of the invention described herein are exemplary and numerous modifications, variations and rearrangements can be readily envisioned to achieve substantially equivalent results, all of which are intended to be embraced within the spirit and scope of the invention. Further, the purpose of the foregoing abstract is to enable the U.S. Patent and Trademark Office and the public generally, and especially the scientist, engineers and practitioners in the art who are not familiar with patent or legal terms or phraseology, to determine quickly from a cursory inspection the nature and essence of the technical disclosure of the application.

What is claimed is new and desired to be protected by Letters Patent is set forth in the appended claims:

1. A lighting control device comprising:
an enclosure with an inner-volume providing a protective housing and at least one mounting surface;
at least one touch-pad with at least one push-button switch;
a transformer for transferring electrical energy from one first circuit to at least one second circuit;
at least one timer;
at least one logic switcher;
at least one logic controller; and
at least one switch;
wherein said power supply is connected to said at least one timer, said at least one logic switcher, said at least one logic controller, and said at least one switch; and
wherein said lighting control device housed by said enclosure is manipulatable via said touch-pad by at least one user thereby creating a capacity to turn a plurality of lights on and off using multiple said switches when said switches are activated by said at least one user.

2. The lighting control device of claim 1 further comprising a user-activatable pre-settable time delay usable to automatically turn off at least one light.

3. The lighting control device of claim 1 wherein said lighting control device can manipulate up to twelve push-button switches.

4. The lighting control device of claim 1 wherein said lighting control device can manipulate more than twelve push-button switches.

5. The lighting control device of claim 1 wherein said lighting control device is portable.

6. The lighting control device of claim 1 wherein said lighting control device is removably installable at different locations within an interior room.

7. The lighting control device of claim 1 wherein said enclosure comprises plastic.

8. The lighting control device of claim 1 wherein said push-button switches are able to be pressed randomly.

9. The lighting control device of claim 8 wherein one of said push-button switches will turn a light on, while any other of said push-button switches or the same said push-button switches can turn said light off.

10. The lighting control device of claim 1 wherein said at least one switch is analog.

11. The lighting control device of claim 1 wherein said at least one switch is digital.

12. The lighting control device of claim 1 wherein said lighting control device is connectable and operable through telephone wires.

13. The lighting control device of claim 1 further comprising at least one buffer.

14. The lighting control device of claim 1 further comprising at least one capacitor.

15. The lighting control device of claim 1 further comprising at least one inverter.

16. The lighting control device of claim 1 further comprising at least one resistor.

17. The lighting control device of claim 1 wherein said lighting control device comprises tri-state circuitry.

18. The lighting control device of claim 1 wherein said lighting control device comprises digital gates.

19. A lighting control device comprising:
a plastic enclosure with an inner-volume providing a protective housing and at least one mounting surface;
at least one touch-pad with at least one push-button input switch;
a transformer for transferring electrical energy from one first circuit to at least one second circuit;
at least one timer;
at least one logic switcher;
at least one buffer for buffering;
at least one capacitor acting electronically passively including a pair of conductors separated by a dielectric insulator;
at least one inverter for converting direct current to alternating current;
at least one logic controller and a user-activatable pre-settable time delay usable to automatically turn off at least one light;
at least one analog and/or digital switch;
at least one resistor that produces a voltage across its terminals that is proportional to the electric current through it;
at least one potentiometer providing an adjustable voltage divider; and
wherein said lighting control device comprises tri-state circuitry and digital gates;
wherein said lighting control device is portable such that said lighting control device is removably installable at different locations within an interior room;
wherein said lighting control device is connectable and operable through telephone wires;
wherein said power supply is connected to said at least one timer, said at least one logic switcher, said at least one logic controller, and said at least one switch;
wherein said lighting control device housed by said enclosure is manipulatable via said touch-pad by at least one user having creating a capacity to turn a plurality of lights on and off using multiple switches when said switches are activated by said at least one user;
wherein said push-button switches are able to be pressed randomly; and
wherein one of said push-button switches will turn a light on, while any other of said push-button input switches or the same said push-button input switches can turn said light off.

20. A method of using a lighting control device comprising the steps of:
pushing at least one push-button switch on a touch-pad thereby activating at least one light at a remote location;
wherein one of said push-button switch(es) will turn said at least one light on, while any other of said push-button switches or the same said push-button switch(es) can turn said light off;
wherein said push-button switch(es) are randomly pressable; and
activating a pre-settable time delay usable to automatically turn off said at least one light.
